(19) United States
(12) Patent Application Publication
(10) Pub. No.: US 2010/0032175 A1
(43) Pub. Date: Feb. 11, 2010

(54) Bubble Fire Extinguisher

(76) Inventor: Joseph J. Boyd, Atlanta, GA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(21) Appl. No.: 12/187,940

(22) Filed: Aug. 7, 2008

(51) Int. Cl. A62C 2/00

(52) U.S. Cl. 169/44

(57) ABSTRACT

A fire fighting process wherein large bubbles are made by blowing batches of a gas through a saponaceous liquid. These bubbles are pumped into a burning building to fill the space and block the air to the fire, and thereby to quickly stop the chemical reaction of combustion.

### BACKGROUND OF THE INVENTION

1. Field of the Invention

The present invention relates generally to a firefighting process for fighting A and B class house fires or other area fires, where the combustion is caused by the chemical reaction of fuel and oxygen in the presence of heat. The present invention relates more specifically to the use of large soapy bubbles to fill a room that is on fire, and to shut off the oxygen to the fire. The bubbles stick together and block the passage of air, and will quickly extinguish the fire.

2. Description of Related Art

Normal fire fighting methods depend almost exclusively on firemen using water or other means to reduce the temperature of the combustion area. This means that the firemen must try to put the water directly on the combustion area, an almost impossible thing on a large fire. The larger the fire, the greater is the total heat generated per cubic foot, and since heat is one of the three requirements of combustion, the greater the heat the harder the fire is to extinguish. Because of this, big fires are almost always difficult to cool down, and since it is dangerous for the firemen to get close, these fires often get completely out of control.

At the present time, most fires are fought by pumping large quantities of water into a burning building, directly onto the fire if possible. This method works by removing the heat of combustion. The water is cold and has a high specific heat and will cool the fuel rapidly if placed directly on the point of combustion. The problem is that it is difficult for the firemen to reach the fire inside the building and sometimes must just shoot the water through the windows from a distance. Even when the water is sprayed directly on a very hot fire, the heat may be removed too slowly to cool the combustion area. The heat must be removed from the entire combustion area to stop the fire, and the ability to stop a fire becomes a balance between the available heat from the fire and the heat needed to boil the water that actually falls on the burning material. The heat from the fire may be hundreds of times that needed to boil the water, and in this case, the fire is out of control, and burns the building. However, if we block all of the oxygen, the flame dies out instantly.

Therefore, it can be seen that a need yet exists for better firefighting processes for fighting A and B class house fires or other area fires. It is to such a system that the present invention is primarily directed.

### BRIEF SUMMARY OF THE INVENTION

Briefly described, in preferred form, the present invention uses bubbles inflated with an incombustible gas, wherein the bursted bubbles help squelch the fire, and since the smoke is trapped in the room, and is incombustible, it too helps to block the oxygen.

Using a heavy gas and a long-lasting soapy solution for the bubbles, the present invention may be used to fight forest fires, both as a fire retardant dropped by airplanes, and as a means of controlling back fires set to slow the main fire.

Fighting fires with bubbles is entirely different to fighting oil fires with foam. The foam is much lighter than the oil and floats on the surface of the oil, effectively blocking off the air. Foam, like the larger bubbles, acts to block the oxygen from the reaction and will instantly stop the fire, but the foam must be applied directly on the fire to be effective. And, if the fuel is very hot, the vapor rises above the foam and continues to burn.

Also, foam differs from bubbles in the way it is produced, how it is applied, and how it acts to stop the fire. A common way the foam is produced is to put soapy water and a gas under pressure in a cylinder. The liquid absorbs the gas. When the liquid is sprayed on the fire, the reduced pressure releases the gas and it forms a froth with the water to smother the fire. Another way of producing the foam is to stir the gas and liquid together to form a froth of fine bubbles, which is sprayed on the fire. In all cases, the volume of foam depends on the amount of froth formed, and since the liquid is converted into very fine bubbles, the volume of foam is only a few times greater than the volume of liquid used.

There is a chemical that may be added to the foam that is said to increase the volume of foam, but the result is still foam, and it would take a thousand times the volume of liquid used by the bubbles to fill a normal room with foam, even if it could be done. Also, if one could fill a building with foam, the foam would suffocate a person trapped in the building, and after the fire the foam and water damage would be extensive. In no way will foam perform like a room full of bubbles.

By rapidly inflating millions of bubbles with carbon dioxide, and pumping them into the room that is afire, there is a minimum of residue after the fire, since almost all of the mixture is gas. Here the ratio of the volume of bubbles to the volume of liquid used may be in the hundreds, and by using only a few gallons of liquid, it is possible to make a room full of bubbles that seals out all outside air to the fire. And the bubbles that burst release a gas, which is incombustible.

In a preferred embodiment, the present invention is a fire fighting process wherein large bubbles are made by blowing batches of a gas through a saponaceous liquid. These bubbles can be pumped onto a forest fire, for example, or into a burning building to fill the space and block the air to the fire, and thereby quickly stop the chemical reaction of combustion. The bubbles can be made by blowing batches of an incombustible gas, such as carbon dioxide, through a saponaceous liquid to form the bubbles. The bubbles can be made by blowing batches of air through a soapy liquid to form the bubbles. The batches of gas can be blown through a solution of soap and water to form the bubbles, to fight the fire.

The bubbles can be made by blowing batches of gas through chemical solutions that form long-lasting bubbles that may be used to stop the spread of fire for a long period of time, such as forest fires.

In another preferred embodiment, where the fire is in one or more rooms of a multi-room structure, the bubbles that smother the fire are filled with incombustible gas, but rooms adjacent to the room(s) on fire are filled with the air bubbles, so that the fire is extinguished by incombustible gas filled bubbles, but is prevented from spreading to the adjacent rooms by the air filled bubbles, and where any people trapped, can break enough air bubbles to breathe, without smoke inhalation, which will allow them to escape through the bubbles to safety.

In another preferred embodiment, the bubbles are made by blowing batches of a mixture of helium and other incombustible gasses through a saponaceous liquid to form the bubbles, so the bubbles are almost weightless and can be pumped many stories to fight fires in multistoried buildings.

The present invention can further comprise a bubble generator that is a self-contained unit in an enclosed area, such as a room, a ship, or an airplane. The bubble generator can be a self-contained unit that is centrally located in a multi room building, and is equipped to deliver bubbles to selected rooms to fight a fire.

The bubble generator can be a self-contained unit that may be carried to the fire, as on a fire truck, and pushed through the window of a burning building, to fill the rooms with bubbles and smother a fire. The bubble generator can be a part of the firefighting equipment, wherein the bubbles are pumped into a burning building to smother a fire.

The present invention can further comprise bubbles used to fight forest fires, wherein the bubbles are used to control backfires set to burn an area to limit the spread of a forest fire, or where a layer of long-lasting bubbles inflated with an incombustible gas is put down to slow an oncoming forest fire, or where the bubbles made of a heavy incombustible gas and long-lasting saponaceous liquid are dropped directly on a forest fire to smother or extinguish it.

These and other objects, features and advantages of the present invention will become more apparent upon reading the following specification in conjunction with the accompanying drawing figures.

### BRIEF DESCRIPTION OF THE DRAWINGS

FIG. 1 is a cut away view of a bubble generator.

FIG. 2 is a view of a fire truck that has pushed a bubble hose through a window of a burning house.

FIG. 3 is a view of an airplane dropping loads of bubbles, to act as a retardant on a forest fire.

FIG. 4 is a view of a firefighter putting down a line of bubbles to limit the spread of a back-fire set to stop a wildfire.

### DETAILED DESCRIPTION OF PREFERRED EMBODIMENTS

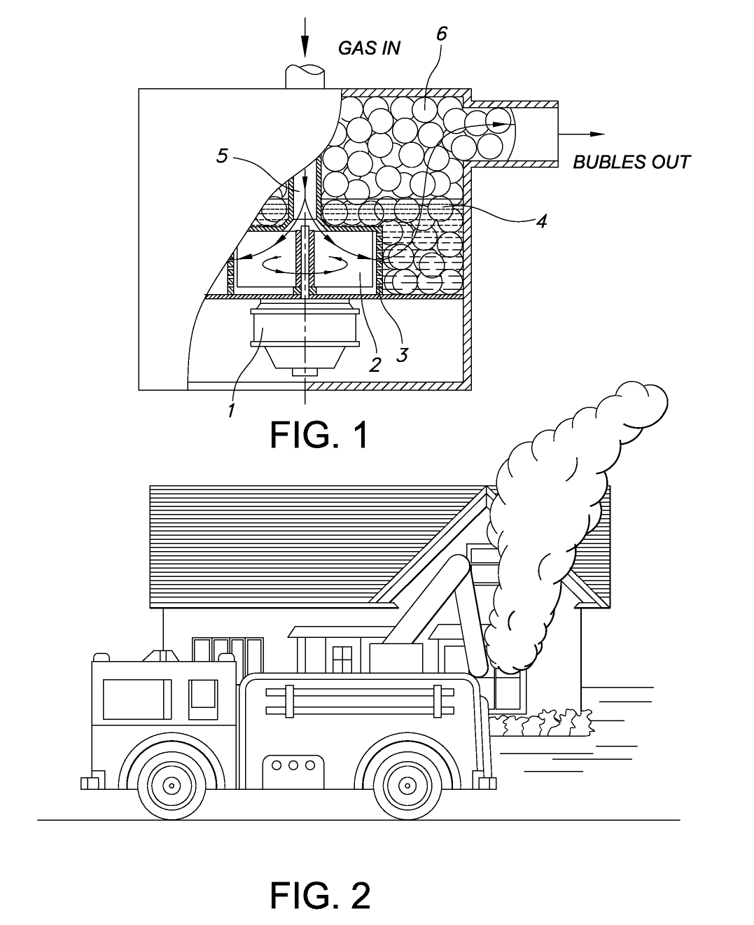

Referring now in detail to the drawing figures, FIGS. 1-4 illustrate various elements of the present invention.

To generate the bubbles used, a number of different processes may be used. All are based on the principle of chopping a stream of gas into small batches as it passes through a soapy liquid. The generator may draw in the gas with rotating vanes and let the vanes separate the passing gas into small batches as it goes through holes in a panel into the soapy liquid. Or the bubbles may be formed by rapidly stirring a soapy solution while inducing a gas. Each small batch of gas, cut off from the main stream of gas, forms a bubble, and the bubbles pile one on top of the other, to form a larger and larger pile of bubbles. The size of the bubbles is determined by the number of small batches of gas per volume of gas, and this is determined by the size of the openings and the speed of the generator.

The mixture may be water and soap, or a saponaceous nonflammable liquid, and the gas that inflates the bubbles that are used in close to the fire should be carbon dioxide or some other inert gas. Helium gas may be used for high buildings, and will lift the bubbles as high as needed. The gas that inflates the bubbles used to fill the rooms, a distance away from the fire, should be ordinary air. This prevents the smoke and hot fumes from filling the rooms adjacent to the fire, and killing the people trapped in the building. Those trapped in the rooms filled with air bubbles can break enough bubbles to breathe and escape.

There are special chemicals that can be added to the mixture to produce bubbles that are longer lasting than the bubbles used in house fires, and a gas heavier than carbon dioxide may be used to make the bubbles fall to the ground faster. These bubbles could be used to slow the spread of forest fires. They could be put down by an airplane directly on the fire, or used to form a thin layer of inert gas over the vegetation ahead of an oncoming fire. They could also be used to control backfires, set ahead of an oncoming wildfire.

The bubble generators may be battery operated and carried in vehicles such as airplanes and buses to protect the people in case of a fire.

In FIG. 1 is shown a method of making the bubbles wherein the motor 1 drives the vanes 2 inside of a perforated stator 3. The stator has many holes in its cylindrical sides that allow gas to pass through, and the unit is submerged in the soapy liquid 4. The rotor has a central opening 5 for the incoming gas, which is pushed through the holes in the stator in batches to form bubbles 6 other types of batching equipment may be used, since the gas might be under pressure and drive the rotor as it expands. Or, the gas may be pumped in and batched by a rotating cup inside the stator.

Many types of motors may be used to drive the rotor, and other means of breaking the gas into batches to form the bubbles, such as rapidly opening and closing valves in a gas line, that opens into a container of saponaceous liquid to form the bubbles, may be used. Methods other than those described above may be used without limiting the scope of this disclosure.

The bubbles in the generator rise to the top, and if the bubble unit is just a room unit or a small area unit, the bubbles spill out to fill the area. If the unit is larger or mounted on a fire fighting rig, as shown in FIG. 2, the bubbles are collected in a larger container and blown into the burning area.

A room type bubble generator may be located in a closet, or the unit may be a permanent fixture in airplanes, railroad cars and ships. It may be portable or built in. The generator may be centrally located to serve a number of rooms, as in a hotel or office building.

A fire truck with a large bubble generator can pull in close to a burning building, as is shown in FIG. 2, push a large hose 10 through the window and pump an ordinary room full of bubbles in a few minutes. If the fire is in the room, and the bubbles are inflated with carbon dioxide and fill the room, all of the oxygen will be cut off from the fire, and the fire will instantly be extinguished. But even a room full of air bubbles will extinguish the fire because, although some bubbles burst, and release some air, it would do little to keep the fire going. If people are in the house, the bubbles, inflated with carbon dioxide could be used in close to the fire and ordinary air inflated bubbles could be used away from the fire or in the other rooms to prevent the spread of the fire. Any person trapped in the house can break the air bubbles to get enough air to breathe, and so, make their way to safety. This would be of great value to people trapped in burning buildings away from the fire, since many of these people die of smoke inhalation instead of from the heat.

The bubbles may be produced by a self-contained bubble generator, which could be a permanent fixture in the building, or it could be pushed through the window of a burning house by the fire truck, or it could be a part of the fire truck and a blower could blow the bubbles into the room, as is shown in FIG. 2.

Also, the generator could be a unit permanently installed in the rooms of hotels or other buildings, or in ships and airplanes, which would start operating automatically from the heat of a fire. In the fire that destroyed the world trade center, the present invention would have limited the damage to only the that caused by the airplanes. It would have prevented the fires that weakened the steel structure of the building.

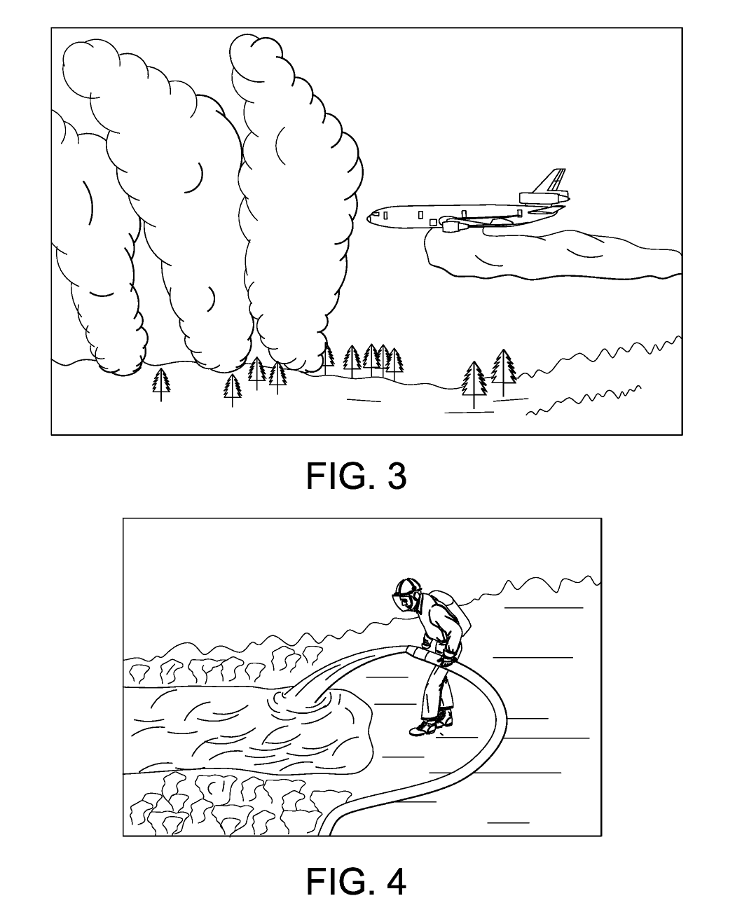

Bubbles inflated with an incombustible heavy gas and composed of long-lasting soapy solutions can be used to slow forest fires, as is shown in FIG. 3. One advantage here is that a load of gas and saponaceous liquid would allow the plane to make many passes over the burning area, dumping a load of bubbles each pass.

FIG. 4 shows a firefighter putting down a layer of bubbles to control a back-fire, used to slow forest fires. The advantage here is that long-lasting bubbles would allow larger areas to be burned at each setting. Also in using water we must keep a large area wet for a long period of time. Long-lasting bubbles would shut off the air and prevent the back fire from getting out of control.

While the invention has been disclosed in its preferred forms, it will be apparent to those skilled in the art that many modifications, additions and deletions can be made thereupon without departing from the spirit and scope of the invention and its equivalents as set forth in the following claims.

What is claimed is:

1. A fire fighting process comprising:
forming bubbles by blowing batches of a gas through a saponaceous liquid; and
providing the bubbles to a fire.

2. The fire fighting process of claim 1, wherein the fire is in at least one room of a building, and the bubbles fill the at least one room, and block air to the fire, thereby extinguishing the fire.

3. The process of claim 1, wherein the bubbles are made by blowing batches of an incombustible gas through the saponaceous liquid.

4. The process of claim 3, wherein the incombustible gas is carbon dioxide.

5. The process of claim 1, wherein the bubbles are made by blowing batches of air through a soapy liquid.

6. The process of claim 2, wherein the bubbles provided to the fire are filled with an incombustible gas, and further comprising filling other portions of the building with bubbles filled with air, to enable fleeing people from the building to move safely through such portions of the building with bubbles filled with air, and to safety.

7. The process of claim 1, wherein the bubbles are made by blowing batches of gas through chemical solutions that form long-lasting bubbles that may be used to stop the spread of fire.

8. The process of claim 1, wherein the bubbles are made by blowing batches of a mixture of helium and other incombustible gasses through a saponaceous liquid.

9. The process of claim 1, wherein the step of forming bubbles comprises a self-contained unit.

10. The process of claim 9, wherein the bubble generator is a self-contained unit located in a multi room building, and equipped to deliver bubbles to selected rooms to fight the fire.

11. The process of claim 9, wherein the bubble generator is a self-contained unit that is transportable to the fire.

12. The process of claim 1, wherein the bubbles are used to fight forest fires.
